(19) United States
(12) Patent Application Publication
(10) Pub. No.: US 2008/0191399 A1
(43) Pub. Date: Aug. 14, 2008

(54) HIGH STABILITY PLANAR SPRING UTILIZED IN A VOICE COIL MOTOR

(75) Inventor: Wen Chia Chang, Chu-Bei City (TW)

Correspondence Address: LOWE HAUPTMAN HAM & BERNER, LLP, 1700 DIAGONAL ROAD, SUITE 300, ALEXANDRIA, VA, 22314, US

(73) Assignee: Mustek Systems Inc., Hsin-Chu City (TW)

(21) Appl. No.: 11/851,289

(22) Filed: Sep. 6, 2007

(30) Foreign Application Priority Data
Feb. 13, 2007 (TW) 096202706

(51) Int. Cl. F16F 1/34

(52) U.S. Cl. 267/161

(57) ABSTRACT

A high stability planar spring utilized in a voice coil motor comprises a fixed portion, a deformation portion, a sustaining portion, a force-receiving portion and a stabilized portion. The force-driven portion is connected to the fixed portion by the deformation portion and the sustaining portion in order to maintain the same plane with the fixed portion. The stabilized portion extends from the sustaining portion to the gap between the fixed portion and the sustaining portion.

### RELATED APPLICATION

The present application is based on, and claims priority from, Taiwanese Application Number 096202706, filed Feb. 13, 2007, the disclosure of which is hereby incorporated by reference herein in its entirety.

### FIELD OF THE INVENTION

The present invention relates to a high stability planar spring, in particular, a high stability planar spring for voice coil motor. The planar spring according to the invention allows shortened response-time and eliminates the need for an additional damper or additional elasticity.

### BACKGROUND OF THE INVENTION

Due to the fast development of the mobile communication and electronic industry, there is always an urgent demand for more compact and small-sized electronic product. However, machinery and electric equipments has their limits, Micro-electromechanical Systems is currently far from prevalence. Thus, VCM (voice coil motor) is now widely used to provide actuation for electronic products.

The advantages of VCM exist in its small size, low energy consumption, accurate actuation and cheapness. VCM is ideal for short distance movement control, such as the vibration motor for mobile phone, magnetic head/optical pickup head actuator of storage equipment, AF (auto-focus) actuator for a zoom lens of camera, et al. However, compared with the electronic portion of a cell phone, which operates at a speed of millisecond-level, the actuating and restoring speed of VCM is relatively slow. Thus, VCM normally includes an elastic element to accelerate actuating or restoring movement.

A schematic view of a traditional VCM of AF camera is shown in FIG. 1. The VCM includes an upper lid 11, a lower lid 12 and a frame 13 having four magnetic elements 14 positioned on the four sides of the frame 13, a lens mount 15 enclosed by the four magnetic elements 14, a zoom lens 16 contained in the lens mount 15, an upper coil 17 and a lower coil 18 fixed on the lens mount 15. The lens mount 15 is movably positioned within a passage encircled by the four magnetic elements 14, and further positioned within frame 13. When the upper coil 17 and the lower coil 18 are electrified, they will be repelled or attracted by a magnetic field generated by the four magnetic elements 14, such that the lens mount 15 will be actuated or restored. A single planar spring 19 or a set of planar springs 19 functions to accelerate the actuating or restoring movement of the lens mount 15.

A traditional planar spring is shown in FIG. 2. Response-Time is a very important parameter for VCM, which indicates the capability of a cell phone camera. Testing a Response-Time includes introducing an 80 mA AC current pulse to VCM, recording the time a lens mount 15 takes from its start up until the lens mount 15 is in a transient stable status. A transient stable status means a lens mount 15 maintains stable at a position with its stroke less than 10 um. FIG. 3 schematically demonstrates current pulse and the stroke of a VCM.

Actually, a response-time is the period for a balance to be reach between the Lorentz force applied on the movable part and elasticity of the planar spring. As shown in FIG. 1, when coils (upper coil 17 and lower coil 18) are driven by the Lorentz force of the magnetic field (generated by magnetic elements 14), the coils actuate the movable part towards Z+. Then, the planar spring is pressed and deformed. Thus, when the Lorentz force along Z+ equal to the elasticity provided by the planar spring, a stable balance is achieved, and a transient stable status is obtained.

In view of the afore-mentioned disadvantages of the prior art, there is a need for enhanced planar spring which overcome the shortcoming of the traditional planar spring of VCM.

### SUMMARY OF THE INVENTION

One of the objects of the present invention is to provide a planar spring of VCM (voice coil motor) having a high stability. The planar spring facilitates shortening the Response-Time of VCM without any additional higher elasticity of the planar spring and maintaining low energy consumption.

According to the above-mentioned object, the planar spring of the instant invention includes a secured portion for maintaining the shape of the planar spring; a deformation portion extending inwardly from the inner loop of the secured portion; a supporting portion connecting to the secured portion through the deformation portion; a force receiving portion connecting the remote end of the supporting portion; stabilizing portion extending from the conjunction of the supporting portion and the force receiving portion and is positioned between the supporting portion and the secured portion. According to another aspect of the present invention, the secured portion is secured to an outer frame of the VCM, and the force receiving portion is secured to a lens mount.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a schematic exploded view of a Voice Coil Motor of prior art;

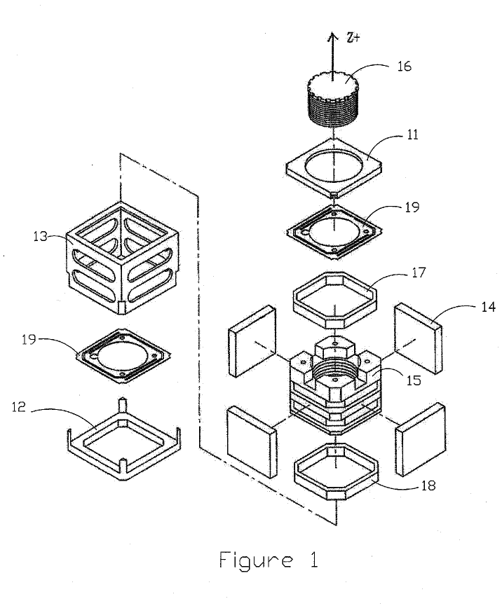

FIG. 2 illustrates a traditional planar spring used in a VCM;

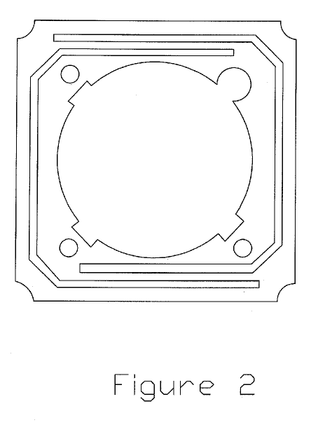

FIG. 3 is a schematic representation of the Response-Time and VCM stroke of a VCM in response to the actuation of a current pulse;

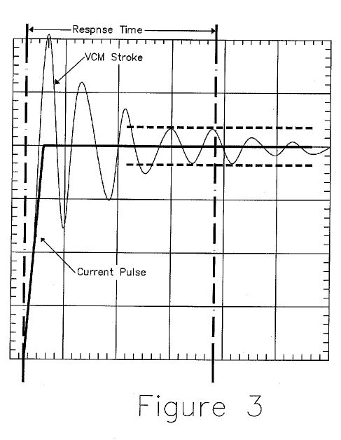

FIG. 4 is a vertical view of a planar spring according to a preferred embodiment of the present invention; and

FIG. 5 is a schematic representation of the response-time and VCM stroke in response to the actuation of current pulse, wherein the VCM has a planar spring according to a preferred embodiment of the present invention.

### DETAILED DESCRIPTION OF THE INVENTION

The details, structural features and functions of the embodiments of the present invention will be described in details with reference to the accompanying drawings.

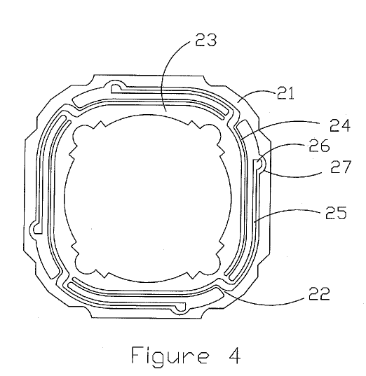

As shown in FIG. 4, a high-stability planar spring of the instant invention includes a secured portion 21, a deformation portion 22, a force-receiving portion 23, a supporting portion 24 and a stabilizing portion 25. The secured portion 21 is connected to the movable part of the VCM. For example, when a VCM is used by an AF system of a camera lens, the movable part is a lens mount engaged with a set of lens; when a VCM is used in a storage device, the movable part could be magnetic head or optical pickup head. According to this embodiment, the secured portion 21 has four boundary edges, and the four boundary edges are arc-shaped. There are recesses defined on the outer loop of the secured portion, and the recesses are configured to engage with the movable part of the VCM.

The deformation portion 22 extends from the inner loop of the secured portion 21. The length and width of the deformation portion 21 are configured depending on demand and the use of the spring. The supporting portion 24 is a rib extending from one end of the deformation portion 22. The length and width of the supporting portion 24 are configured depending on demand and the use of the spring. The far end of the supporting portion 24 crooks and connects to a force-receiving portion 23.

The inner loop of the force-receiving portion 23 connects to the movable part (for example lens mount 15). The inner loop of the force-receiving portion 23 has a plurality of recesses for engaging with the movable part. In addition, in an opposite direction to the connection with force-receiving portion 23, and adjacent to the conjunction point with the supporting portion 23, the stabilizing portion 25 extending from the supporting portion 24. The far end of the stabilizing portion 25 has a protrusion 26. The protrusion 26 is configured to regulate the response performance of the planar spring. Moreover, if the size of the protrusion 26 is bigger than the space defined by the secured portion 21 and the supporting portion 24, the inner loop of the secured portion 21 could be further configured to include a slot 27 for receiving the protrusion 26. According to the current embodiment, there are four stabilizing portions. However, more desirable amount of the stabilizing portions 25, the protrusions 26, supporting portion 24 and deformation portions 22 can be used depending in demand.

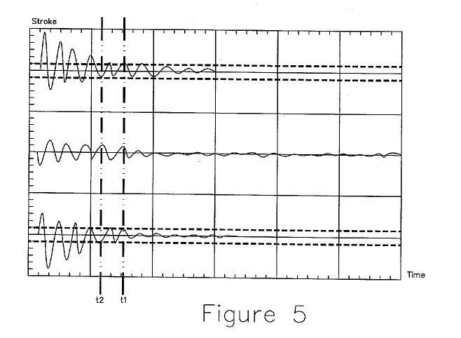

In accordance with the above discussion, there are two main method for optimizing the response-time: the first, adding additional damping; the second, using a spring with higher elasticity. However, VCMs are minute motors, and are thin and small so as to particularly meet the demand as being used in cell phone cameras. Thus, a minute size is a prospect in designing VCMs, and additional damping conflicts with this prospect. As for higher elasticity spring, a higher elasticity, in return, would require higher current value to drive the motor, and this will result in higher energy consumption and limit the continuous hours of the battery. Therefore, according to this embodiment, the stabilizing portion 25 can corporate with the protrusion 26, such that, when the VCM operates, the stabilizing portion 25 and the protrusion 26 provide a reversed shock. More specifically, following the inertia rule, when the movable part moves, the stabilizing portion 25 and the protrusion 26 could provide an inertial force that is in an opposite direction to the movement of the movable part. In a transient moment of a response-time, the reverse force, provided by the stabilizing portion 25 and the protrusion 26, could counteracts the inertia of the movable part of the VCM. Thus, as shown in FIG. 5, the response-time is substantially shortened, especially no addition damping is added. The configuration of the stabilizing portion 25 and the protrusion 26 facilitates reduction of the response-time.

Although the preferred embodiments of the present invention have been described herein, the above description is merely illustrative. Further modification of the invention herein disclosed will occur to those skilled in the respective art and all such modifications are deemed to be within the scope of the invention as defined by the appended claims.

1. A planar spring for a voice coil motor having a secured part and a movable part, comprising:
a secured portion configured to engage with the secured part of the voice coil motor;
a deformable portion having a first end and a second end, the first end of the deformable portion connects to the secured portion, the second end connects to the movable part of the voice coil motor;
and
a stabilizing portion extending from the second end of the deformable portion and is positioned between the deformable portion and the secured portion.

2. The planar spring of claim 1, further comprises a protrusion positioned at an end of the stabilizing portion.

3. The planar spring of claim 1, wherein the planar spring has a round shape, and the secured portion is secured to the voice coil motor through an outer frame.

4. The planar spring of claim 1, wherein the second end of the deformable portion is further secured to a movable part of the voice coil motor.

5. The planar spring of claim 4, wherein when the movable part of the voice coil motor is driven by a force, the deformable portion will be distorted; and when the force is removed, the moveable part will be restored by the elasticity of the distorted deformable portion.

6. The planar spring of claim 1, wherein the stabilizing portion is configured to provide a counteractive inertial force to the second end of the deformable portion in a direction which is opposite to the movement of the second end of the deformable portion.

7. The planar spring of claim 1, wherein the second end of the deformable portion receives a force, the deformable portion, and the stabilizing portion will be bended; when the force is removed, the elasticity of the deformable portion, and the stabilizing portion will be released and the deformable portion, and the stabilizing portion will be restored by the elasticity and an inertia force.

8. A planar spring for a voice coil motor, comprising:
a secured portion having an inner loop;
a deformation portion extending inwardly from an inner loop of the secured portion;
a supporting portion having a first end and second end, and first end of the supporting portion connects to the secured portion through the deformable portion;
a force-receiving portion connecting to the second end of the supporting portion; and
a stabilizing portion having a first end and a second end, the first end of the stabilizing portion connects to the outer edge of an conjunction point of the supporting portion and the force-receiving portion, and is aligned between the supporting portion and the secured portion.

9. The planar spring of claim 8, wherein the VCM has an out frame and the secured portion is secured to the outer frame of the VCM.

10. The planar spring of claim 8, wherein the VCM further comprises a lens mount, and the force-receiving portion engages with a lens mount.

11. The planar spring of claim 8, further includes a protrusion positioned at the second end of the stabilizing portion and is semicircle-shaped.
